(19) United States
(12) Patent Application Publication
(10) Pub. No.: US 2022/0198103 A1
(43) Pub. Date: Jun. 23, 2022

(54) MODELING SYSTEM AND MODELING APPARATUS, MODELING METHOD, AND MODELING PROGRAM

(71) Applicant: MITSUBISHI HEAVY INDUSTRIES, LTD., Tokyo (JP)

(72) Inventors: Hiroki MORI, Tokyo (JP); Akihiro TANAKA, Tokyo (JP); Takahiro TACHIBANA, Tokyo (JP); Yasutaka BANNO, Tokyo (JP); Hidenori TAKEDA, Tokyo (JP); Misaki FUKUYAMA, Tokyo (JP)

(21) Appl. No.: 17/557,856

(22) Filed: Dec. 21, 2021

(30) Foreign Application Priority Data
Dec. 23, 2020 (JP) 2020-213099

(51) Int. Cl. G06F 30/23; B32B 41/02; B33Y 50/02; B33Y 10/00

(52) U.S. Cl. CPC G06F 30/23; B32B 41/02; G06F 2113/10; B33Y 10/00; B33Y 50/02

(57) ABSTRACT

A modeling system (control device) includes a control unit that controls a modeling means to form each of stacked modeling layers, based on modeling data representing a three-dimensional model object that is a modeling target by use of a plurality of modeling layers, a determination unit that measures and determines whether or not a measured value of a stacked height of the formed modeling layer is within a predetermined range set beforehand and including a stacked height of the modeling layer in the modeling data, and in a case where the formed modeling layer has a lacking part in which the stacked height is not within the predetermined range, a correction unit that performs correction modeling by forming a correction member in the lacking part such that the stacked height is within the predetermined range.

### CROSS-REFERENCE TO RELATED APPLICATIONS

This application claims priority to Japanese Patent Application No. 2020-213099 filed Dec. 23, 2020, the contents of which are incorporated herein by reference in its entirety.

### BACKGROUND OF THE INVENTION

### 1. Field of the Invention

The present disclosure relates to a modeling system and modeling apparatus, a modeling method, and a modeling program.

### 2. Description of Related Art

For example, in a 3D printer, a three-dimensional model object is modeled by forming a plurality of modeling layers. Specifically, the three-dimensional model object is modeled by representing a shape of the three-dimensional model object as a modeling target with a plurality of modeling layers in pseudo manner, and then forming respective modeling layers (e.g., Patent Literature 1).

### CITATION LIST

### Patent Literature

[Patent Literature 1] Japanese Unexamined Patent Application, Publication No. 2019-155606

### BRIEF SUMMARY OF THE INVENTION

### Technical Problem

In a case of stacked modeling (so-called additive manufacturing), a concavo-convex shape of a layer surface may affect a modeling quality and shape of the next layer. For example, an internal defect, incomplete fusion or the like may occur. In Patent Literature 1, an additional layer is formed in a low region, and it is considered that the modeling quality can be further improved by controlling modeling of the additionally formed layer.

An object of the present disclosure, which has been made in view of such situations as described above, is to provide a modeling system and modeling apparatus, a modeling method, and a modeling program that can improve a modeling quality.

### Solution to Problem

The present disclosure in a first aspect provides a modeling system comprising a control unit that controls a modeling means to form each of stacked modeling layers, based on modeling data representing a three-dimensional model object that is a modeling target by use of a plurality of modeling layers, a determination unit that determines whether or not a measured value of a stacked height of the formed modeling layer is within a predetermined range set beforehand and including a stacked height of the modeling layer in the modeling data, and in a case where the formed modeling layer has a lacking part in which the stacked height is not within the predetermined range, a correction unit that performs correction modeling by forming a correction member in the lacking part such that the stacked height is within the predetermined range.

The present disclosure in a second aspect provides a modeling method including a step of controlling a modeling means to form each of stacked modeling layers, based on modeling data representing a three-dimensional model object that is a modeling target by use of a plurality of modeling layers, a step of determining whether or not a measured value of a stacked height of the formed modeling layer is within a predetermined range set beforehand and including a stacked height of the modeling layer in the modeling data, and in a case where the formed modeling layer has a lacking part in which the stacked height is not within the predetermined range, a step of performing correction modeling by forming a correction member in the lacking part such that the stacked height is within the predetermined range.

The present disclosure in a third aspect provides a modeling program that causes a computer to execute processing of controlling a modeling means to form each of stacked modeling layers, based on modeling data representing a three-dimensional model object that is a modeling target by use of a plurality of modeling layers, processing of determining whether or not a measured value of a stacked height of the formed modeling layer is within a predetermined range set beforehand and including a stacked height of the modeling layer in the modeling data, and in a case where the formed modeling layer has a lacking part in which the stacked height is not within the predetermined range, processing of performing correction modeling by forming a correction member in the lacking part such that the stacked height is within the predetermined range.

### Advantageous Effect of the Invention

The present disclosure exhibits an effect that a modeling quality can be improved.

### BRIEF DESCRIPTION OF THE SEVERAL VIEWS OF THE DRAWINGS

FIG. 1 is a diagram showing a schematic configuration of a modeling apparatus according to a first embodiment of the present disclosure.

FIG. 2 is a diagram showing a schematic configuration of a modeling means according to the first embodiment of the present disclosure.

FIG. 3 is a diagram showing an example of a hardware configuration of a control device according to the first embodiment of the present disclosure.

FIG. 4 is a functional block diagram showing functions included in the control device according to the first embodiment of the present disclosure.

FIG. 5 is a view showing an example of a predetermined range according to the first embodiment of the present disclosure.

FIG. 6 is a view showing an example of a lacking part according to the first embodiment of the present disclosure.

FIG. 7 is a view showing a setting example of a modifying path corresponding to pattern 1 according to the first embodiment of the present disclosure.

FIG. 8 is a view showing a setting example of a modifying path corresponding to pattern 2 according to the first embodiment of the present disclosure.

FIG. 9 is a flowchart showing an example of a procedure of modeling processing according to the first embodiment of the present disclosure.

FIG. 10 is a view showing an example of a path direction corresponding to pattern 1 according to a second embodiment of the present disclosure.

FIG. 11 is a view showing an example of a path direction corresponding to pattern 2 according to the second embodiment of the present disclosure.

### DETAILED DESCRIPTION OF THE INVENTION

### First Embodiment

Hereinafter, description will be made as to a first embodiment of a modeling system and modeling apparatus, a modeling method, and a modeling program according to the present disclosure, with reference to the drawings.

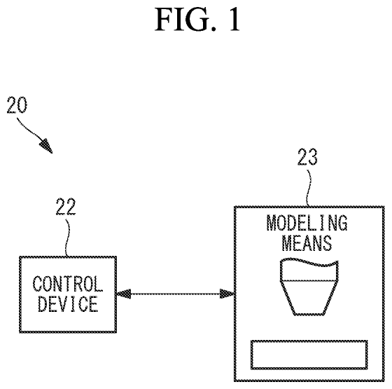

FIG. 1 is a diagram showing a schematic configuration of a modeling apparatus 20 according to a first embodiment of the present disclosure. Note that in the present embodiment, description is specifically made as to a case where a deposition modeling process (hereinafter, referred to as “DED”) is adopted as the modeling apparatus 20. The deposition modeling process is also called a directed energy deposition process. In the present embodiment, the case where the DED is adopted is described, but another modeling process may be adopted. Examples of the other modeling process include fused filament fabrication (FFF), selective laser sintering (SLS), material jetting (MJ), electron beam melting (EBM), and a stereolithography apparatus (SLA). Thus, the modeling method is not limited.

As shown in FIG. 1, the modeling apparatus 20 includes, as a main configuration, a modeling means 23 and a control device (a modeling system) 22.

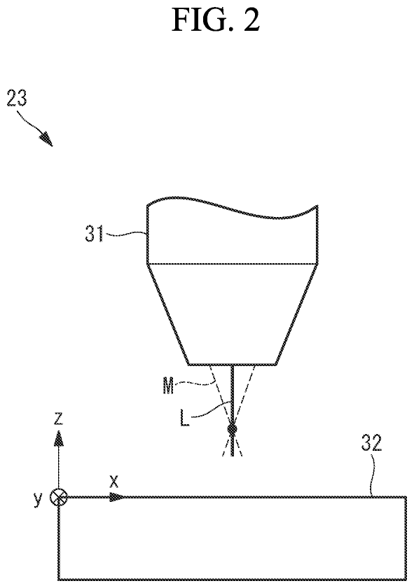

The modeling means 23 is a device that models a three-dimensional model object that is a modeling target. The modeling means 23 is controlled by the control device 22. As shown in FIG. 2, the modeling means 23 includes a head 31 and a stage 32. In the present embodiment, a plane parallel to a stage surface is an x-y plane, and a vertical direction (i.e., a stacked height) is a z-direction. The modeling means 23 forms a modeling layer made of a modeling material on the stage 32 with the head 31 that is movable in parallel with the x-y plane. Thus, a first layer of the three-dimensional model object is formed. Upon forming the modeling layer, the head 31 moves by a height of one layer (stacking pitch) in the z-direction to form the next layer. The modeling means 23 repeats this operation to stack a plurality of modeling layers, thereby forming the three-dimensional model object.

Note that the above description is a description of a case where the head 31 moves along the x-y plane or in a z-axis direction, but a moving process is not limited. For example, the stage 32 may move in the z-axis direction.

A specific modeling method of the modeling means 23 is a DED process. In DED, the modeling material is supplied from the head 31. The modeling material is, for example, a metal material or the like, and is injected together with a carrier gas as shown with M in FIG. 2. Then, laser (appropriate heat source) L is further supplied from the head 31. Specifically, the modeling material is dissolved and coagulated with the laser L, to form beads of the modeling material. The modeling layer is formed by forming the beads while the head 31 is moving along the x-y plane.

The modeling means 23 is provided with a sensor (monitoring device) as a measurement means for measuring a shape of the modeling layer. The sensor measures a surface shape (i.e., the stacked height) of the formed modeling layer. Timing to perform the measurement is not limited. As the sensor, various methods such as a laser scan method and a camera method may be adopted.

Ideally, if modeling is performed based on modeling data, a modeling layer having a stacked height matching that of the modeling layer set in the modeling data should be formed. However, realistically, an ideal modeling layer might not be modeled due to various influences of an environmental factor, a physical factor and the like. In this case, for example, the modeling layer might have a surface shape with a partially low or high stacked height. Such surface unevenness has a possibility of causing deterioration of the modeling quality, such as internal defect or incomplete fusion, and hence the measurement is performed with the sensor.

The control device (modeling system) 22 controls the modeling means 23, to model the three-dimensional model object that is the modeling target.

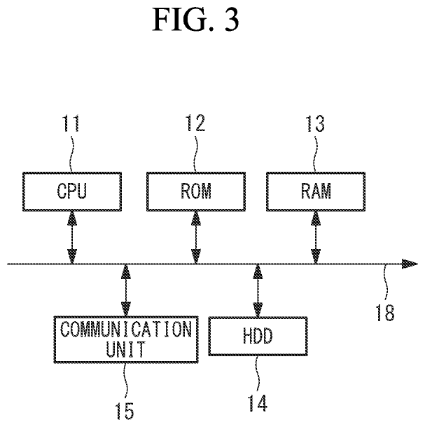

FIG. 3 is a diagram showing an example of a hardware configuration of the control device 22 according to the present embodiment.

As shown in FIG. 3, the control device 22 is a computer system (calculator system), and includes, for example, a CPU 11, a read only memory (ROM) 12 for storing a program or the like to be executed by the CPU 11, a random access memory (RAM) 13 that functions as a work area during the execution of each program, a hard disk drive (HDD) 14 as a large capacity storage device, and a communication unit 15 to be connected to a network or the like. Note that as the large capacity storage device, a solid state drive (SSD) may be used. These respective units are connected via a bus 18.

The control device 22 may include an input unit including a keyboard, a mouse and others, a display unit including a liquid crystal display device or the like that displays data, and the like.

Note that a storage medium for storing the program or the like to be executed by the CPU 11 is not limited to the ROM 12. For example, another auxiliary storage device such as a magnetic disk, a magneto-optical disk or a semiconductor memory may be used.

A series of processing processes for achieving various functions described later are recorded in a program form in the hard disk drive 14 or the like, and this program is read into the RAM 13 or the like by the CPU 11, to execute information processing and arithmetic processing, thereby achieving various functions described later. In addition, the program may be applied in a form of being installed beforehand in the ROM 12 or the other storage medium, a form of being provided in a state of being stored in a computer readable storage medium, a form of being delivered via a wired or wireless communication means, or the like. Examples of the computer readable storage medium include the magnetic disk, the magneto-optical disk, a CD-ROM, a DVD-ROM, and the semiconductor memory.

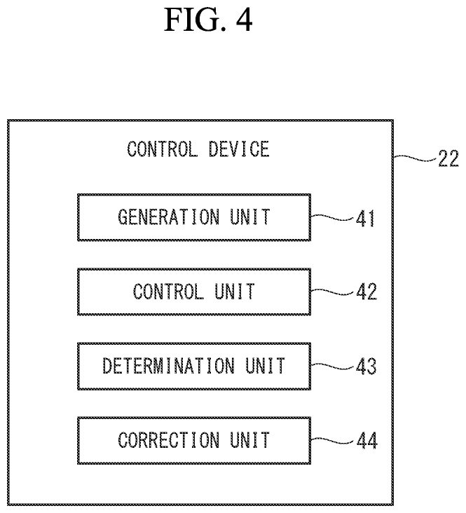

FIG. 4 is a functional block diagram showing functions included in the control device 22. As shown in FIG. 4, the control device 22 includes a generation unit 41, a control unit 42, a determination unit 43, and a correction unit 44.

The generation unit 41 generates the modeling data. The modeling data is information representing the three-dimensional model object that is the modeling target by use of a plurality of modeling layers. Specifically, first, shape data representing a shape of the three-dimensional model object (target model object) is inputted into the generation unit 41. The shape data is prepared, for example, with an information processing device or the like, and inputted into the control device 22. Then, the generation unit 41 divides the shape data by a predetermined stacking pitch unit in a height direction (z-axis direction) of the three-dimensional model object, and generates the modeling data representing a plurality of modeling layers (respective stacked layers). The modeling data is, for example, binary data indicating whether or not to perform modeling in x-y plane coordinates of each layer. Furthermore, it is more preferable that the modeling data includes a parameter such as a modeled amount (stacked height) in the x-y plane coordinates of each layer.

Thus, the generation unit 41 represents the shape data of the three-dimensional model object as the modeling data, and can therefore represent the three-dimensional model object divided into the respective layers, and the three-dimensional model object can be modeled by forming the respective layers.

The control unit 42 controls the modeling means 23 to form each of stacked modeling layers, based on the modeling data. The control unit 42 controls an operation of the modeling means 23 (especially the head 31). The control unit 42 adjusts a position or the like of the head 31 based on the modeling data (design data of the modeling layer), to model the target modeling layer while controlling various parameters such as a modeling speed and the stacked height. In the DED, for example, an amount of the modeling material to be discharged, intensity of the laser L and the like are also controlled.

Specifically, the control unit 42 sets a path (virtual line) for forming the target modeling layer based on the modeling data. Then, the head 31 is operated along the path to form the beads, and the beads accordingly form the modeling layer.

The control unit 42 models the target modeling layer, and then models the modeling layer (i.e., the modeling layer of the next layer) to be stacked on the formed modeling layer. Thus, the three-dimensional model object is modeled by forming the respective stacked modeling layers.

The control unit 42 also executes control of shape measurement of the modeling layer by the sensor. For example, after modeling the modeling layer (or during the modeling), the measurement of the modeling layer is performed. The measurement result is for use in the determination unit 43 described later.

The control unit 42 forms the modeling layer, and controls the stacked height depending on a modeling position, during forming of the modeling layer of the next layer based on the shape measurement result of the formed modeling layer. For example, in a case where the stacked height at a position of the formed modeling layer is high (or low), the modeling layer at this position is formed to be thin (or thick) in the next layer, so that the stacked height of the next layer can be brought close to an ideal stacked height.

The determination unit 43 determines whether or not a measured value of the stacked height of the formed modeling layer is within a predetermined range (construction margin range) set beforehand and including the stacked height of the modeling layer in the modeling data. Specifically, the determination unit 43 compares the stacked height (measured value) at each coordinate position in the x-y plane of the modeling layer, that is measured with the sensor, with the predetermined range based on an ideal value of the stacked height at each coordinate position in the x-y plane of the modeling layer. The ideal value (design value) is the stacked height of the modeling layer in the modeling data at each coordinate position.

The predetermined range (construction margin range) is set beforehand as a range in which the modeling layer to be stacked on the formed modeling layer can be formed such that the stacked height is equal to or more than a predetermined threshold value, based on specifications of the modeling means 23. Specifically, the range is set as a range of a stacked height of a lower layer (modeled layer) such that a modeling height of the modeling layer of an upper layer (unmodeled layer) can be equal to or more than a threshold value (allowable lower limit) through adjustment by the modeling means 23. In other words, if the stacked height of the lower layer is within the predetermined range, the stacked height of the upper layer can be equal to or more than the threshold value (within the predetermined range as described later) through the adjustment by the modeling means 23.

In the present embodiment, the threshold value is set as the lower limit value of the predetermined range. Specifically, if the stacked height of the lower layer is within the predetermined range, the stacked height of the formed upper layer can be within the predetermined range. Note that the threshold value is not limited to the above value, as long as the threshold value is set as the allowable lower limit value of the stacked height of the upper layer.

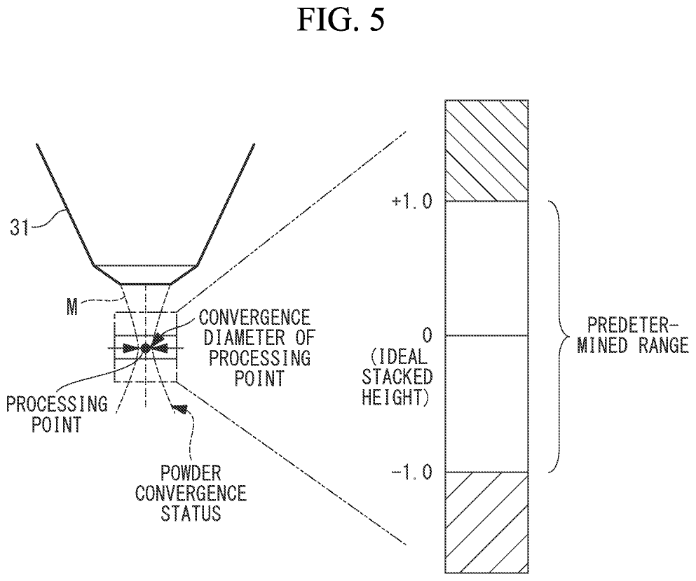

FIG. 5 is a view showing an example of the predetermined range. The predetermined range is set to include an ideal stacked height of the modeling layer (stacked height based on the modeling data). For example, the range is set as a range obtained by adding or subtracting a predetermined distance to or from the ideal stacked height. In the present embodiment, the DED is adopted. In the DED, powder that is the modeling material in the head 31 is concentrated at a processing point away by a predetermined distance from a tip of the head 31. Then, the modeling material concentrated at this processing point is formed into the beads by the laser L. Consequently, as shown in a powder convergence status, it becomes difficult to form the modeling layer as the head 31 moves farther from the processing point. Specifically, in a case of adopting the DED, the predetermined range is set, for example, as a range in which a convergence diameter increases by 10% from a convergence diameter of the processing point. The convergence diameter is, for example, spread of powder convergence at the processing point in an accumulation height direction and vertical direction. That is, the predetermined range set in a stacked height direction is set as a distance by which the convergence diameter of the processing point enlarges by 10%. Specifically, a predetermined distance is set as the ideal stacked height ±1.0 mm. It is more preferable that the range is managed within a range in which the convergence diameter enlarges by 5%.

FIG. 5 shows, as the predetermined range, a range of ±1.0 mm from the processing point at 0 (a center of the predetermined range). Then, the ideal stacked height is shown at the processing point (i.e., 0). That is, the range of ±1.0 mm from the ideal stacked height is the predetermined range (range of −1.0 mm or higher and +1.0 mm or lower than the ideal stacked height). It is assumed that in a region having a stacked height lower than −1.0 mm from the ideal stacked height (region where the stacked height is low), a welding amount decreases, and the next layer therefore has a stacked height away from the predetermined range and cannot be modeled. On the other hand, in a region having a stacked height higher than +1.0 mm from the ideal stacked height (region where the stacked height is high), the next layer is modeled with a low stacked height, and hence the next layer can be modeled at the stacked height within the predetermined range. The predetermined range may be a range of the lower limit value (−1.0 mm) or more.

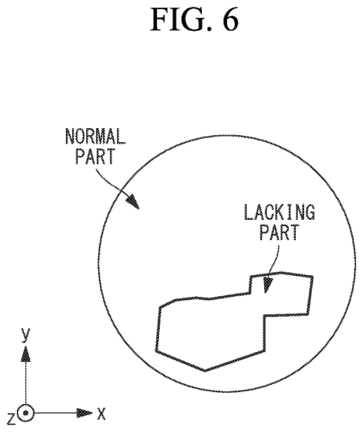

In a case where the formed modeling layer has a lacking part where the stacked height is not within the predetermined range, the correction unit 44 performs correction modeling to the lacking part such that the stacked height is within the predetermined range. The lacking part is a region where the stacked height is lower than the predetermined range in the surface of the modeling layer. FIG. 6 is a view (plan view) showing an example of the lacking part. As shown in FIG. 6, for example, a normal part and the lacking part are seen in a layer surface. As for the lacking part, a position, range or the like is specified in accordance with the determination result in the determination unit 43.

The correction unit 44 performs the correction modeling by forming a correction member in this lacking part. The correction modeling is performed after the modeling layer is modeled and before the next layer is formed. Specifically, the determination unit 43 performs determination processing after each of the modeling layers is formed, and the correction unit 44 performs the correction modeling before the modeling layer to be stacked next is formed, in a case where it is determined in the determination processing that there is the lacking part. In the correction modeling, fleshing (the formation of the correction member) is performed such that the stacked height of the lacking part is within the predetermined range. The correction unit 44 performs the fleshing to the lacking part by setting a path of the correction member (hereinafter, referred to as “the modifying path”), and forming beads of the correction member along the modifying path. In the present embodiment, a case of performing correction modeling of two patterns (hereinafter, referred to as “pattern 1” and “pattern 2”) is described. The correction modeling of one of the two patterns may be performed, or any correction modeling may be selected. Note that a specific method of the correction modeling other than methods of the correction modeling of the patterns 1 and 2 can be adopted, as long as the fleshing is performed such that the stacked height of the lacking part is within the predetermined range.

In the present embodiment, a case where a linear modifying path is formed and beads are modeled along the modifying path to perform the correction modeling is described, but the modifying path is not limited to a linear shape. Further, in the present embodiment, a linear modifying path direction is also set beforehand. Description will be made as to a case of adjusting a path direction in a second embodiment.

The correction modeling of the pattern 1 will be described. The correction unit 44 performs the correction modeling by forming the modifying path only in the lacking part. Specifically, in the pattern 1, the correction modeling is performed only in the lacking part, and the correction modeling is not performed in a region (normal part) other than the lacking part.

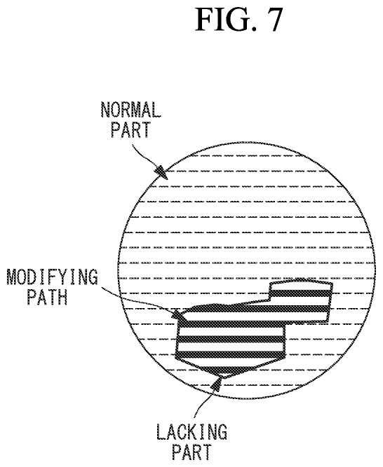

The correction unit 44 sets the modifying path based on the lacking part. FIG. 7 is a view showing a setting example of the modifying path corresponding to the pattern 1. FIG. 7 shows the modifying path with a bold line. In addition, dotted lines represent paths to which the modifying paths can be set, but are not set. A space between respective paths is set such that adjacent beads come in contact with each other when beads are formed along the path. Then, the modifying path (length or the like) is set within a range of the lacking part. As shown in FIG. 7, since the modifying path is set only to the lacking part, the beads are formed along this modifying path, and the lacking part is fleshed. The fleshing is performed such that the stacked height of the lacking part is within the predetermined range.

The path of the correction member is formed only in the lacking part, and hence the formation of the correction member in a part other than the lacking part can be inhibited. Consequently, a modeling time and cost can be reduced.

Next, the correction modeling of the pattern 2 will be described. The correction unit 44 performs the correction modeling by forming the path of the correction member that passes through the lacking part in the formed modeling layer including the lacking part. Specifically, in the pattern 2, the modifying path is formed to pass through the lacking part, and hence the lacking part is entirely subjected to the correction modeling while a partial region of the normal part is also subjected to the correction modeling.

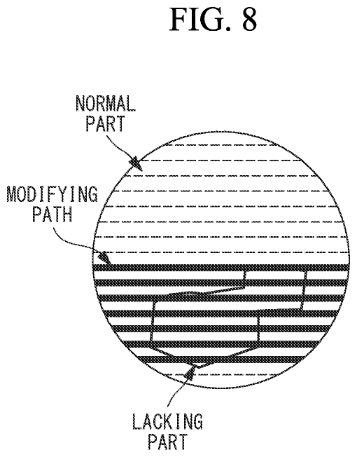

The correction unit 44 sets the modifying path based on the lacking part. FIG. 8 is a view showing a setting example of the modifying path corresponding to the pattern 2. A space between respective paths is set such that adjacent beads come in contact with each other when beads are formed along the path. Furthermore, the modifying path is set to pass through the lacking part in the surface of the formed modeling layer. As shown in FIG. 8, the modifying path is set to pass through the lacking part, beads are therefore formed along this modifying path, and the lacking part is fleshed. As shown in FIG. 8, the modifying path is set to pass through the lacking part, and in other words, the modifying path is not set to a path (a dotted line in FIG. 8) that does not pass through the lacking part in the surface of the modeling layer. The modifying path is not set, and hence a dotted line part in FIG. 8 is not subjected to the correction modeling. Specifically, the modifying path is set only to a part through which the lacking part passes in the surface of the modeling layer, and is not set to another part. The fleshing is performed such that a stacked height of the lacking part is within a predetermined range. Note that, for example, start and end points of the modifying path (formed beads) in the pattern 2 are equal to those of a path of the beads formed when the modeling layer including the lacking part (modeling layer of a modification target) is formed. That is, the start and end points of the modifying path according to the correction modeling are equal to start and end points of a usual bead path formed when the correction modeling is not performed but the modeling layer is formed.

The path of the correction member that passes through the lacking part is formed in the modeling layer including the lacking part, and hence the correction member can be prevented from being formed in a region of the modeling layer that does not pass through the lacking part. Consequently, the modeling time and cost can be reduced. Especially in the DED process, it is harder to model a part that is farther away from the processing point. Therefore, it is possible to perform fleshing of the normal part that is not more than fleshing of the lacking part. In the pattern 2, start and end edges of formed beads are not formed in a boundary portion of the lacking part, and hence an influence of a boundary of the correction modeling can be suppressed in the formation of the next layer.

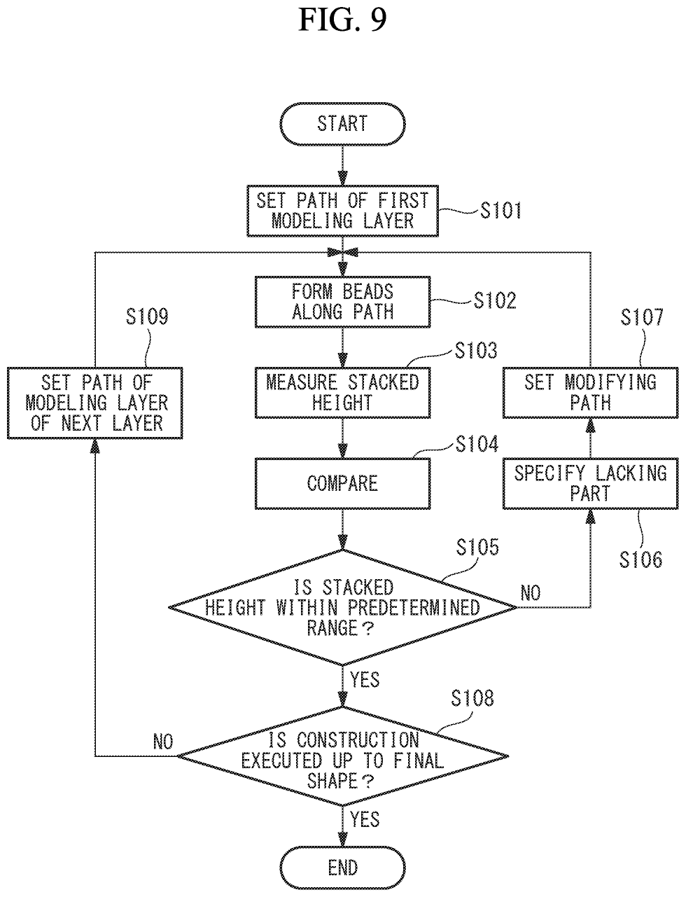

Next, description will be made as to an example of modeling processing by the modeling apparatus 20 with reference to FIG. 9. FIG. 9 is a flowchart showing an example of a procedure of the modeling processing according to the present embodiment. A flow shown in FIG. 9 is executed, for example, in a case of starting modeling of the modeling layer.

First, a path for forming a first modeling layer (modeling layer of a lowermost layer) is set based on the modeling data (S101).

Next, beads are formed along the set path (S102). Consequently, a target modeling layer is formed.

Next, the stacked height of the formed modeling layer is measured with the sensor (S103).

Next, the measurement result of the stacked height is compared with an ideal shape of the modeling data (ideal stacked height) (S104). Specifically, in S104, it is determined at each position of a layer surface whether or not the stacked height of the formed modeling layer is within the predetermined range.

Next, it is determined whether or not the stacked height of the formed modeling layer is within the predetermined range (S105). In S105, if the stacked height is within the predetermined range at each position on the surface of the formed modeling layer, a positive determination is made. On the other hand, if there is a portion having a stacked height that is not within the predetermined range at any position, a negative determination is made.

In a case where the stacked height of the formed modeling layer is not within the predetermined range (NO in S105), the lacking part is specified (S106). In S106, a region of the lacking part is included in the data.

Next, the modifying path is set to the lacking part (S107). In S107, the modifying path is set based on one of the preselected pattern 1 or pattern 2. Upon executing S107, S102 is executed again, but the modifying path is set in S107, and hence beads are formed based on the modifying path in S102.

In a case where the stacked height of the formed modeling layer is within the predetermined range (YES in S105), the lacking part is not detected, and hence it is determined whether or not construction is executed up to a final shape (S108). In other words, it is determined in S108 whether or not the modeling of all the modeling layers included in the modeling data is completed.

In a case where the construction is not executed up to the final shape (NO in S108), the path for forming the modeling layer of the next layer is set (S109). Upon executing S109, S102 is executed again, but the path for the next layer is set in S109, and hence the beads are formed based on the path for the next layer in S102. Thus, the respective layers are modeled.

In a case where the construction is executed up to the final shape (YES in S108), it is determined that the three-dimensional model object is completed to end the processing.

Thus, the modeling and correction modeling of each layer are performed. Especially, in a case where the negative determination is made in S105, the modifying path is set in S106 and S107, and in a case where the negative determination is further made in S105, the modifying path is set again in S106 and S107. Consequently, the correction modeling can be more securely performed such that the stacked height of the lacking part is within the predetermined range, and deterioration of a modeling quality of each layer can be effectively inhibited.

As described above, according to the modeling system and modeling apparatus, the modeling method, and the modeling program of the present embodiment, when forming the respective stacked modeling layers, the correction modeling is performed in the case where there is the lacking part in which the stacked height of the formed modeling layer is not within the predetermined range including the stacked height of the modeling layer in the modeling data (the ideal stacked height). This correction modeling is performed such that the stacked height of the lacking part is within the predetermined range. This can more securely bring the stacked height of the modeling layer close to the modeling data (ideal). That is, stable modeling is possible, and it is possible to form a high-quality model object having, for example, less internal defect or less incomplete fusion.

The predetermined range is set as a range in which the modeling layer to be formed next (the modeling layer to be stacked on the formed modeling layer) can be formed such that the stacked height is equal to or more than a predetermined threshold value, based on specifications of the modeling means 23. Consequently, even if there is the lacking part in the formed modeling layer, the correction modeling is performed, so that the modeling layer to be formed next can more securely indicate the threshold value or more, and it is possible to inhibit generation of a depressed part.

The path of the correction member is formed only in the lacking part, and hence the formation of the correction member in the part other than the lacking part can be inhibited. Consequently, the modeling time and cost can be reduced.

The path of the correction member that passes through the lacking part is formed in the modeling layer including the lacking part, and hence the correction member can be prevented from being formed in a region of the modeling layer that does not pass through the lacking part. Consequently, the modeling time and cost can be reduced.

### Second Embodiment

Next, description will be made as to a modeling system and modeling apparatus, a modeling method, and a modeling program according to a second embodiment of the present disclosure.

In the aforementioned first embodiment, it has been described that the direction of the modifying path is set beforehand, and in the present embodiment, description will be made as to a case of controlling the direction of the modifying path. Hereinafter, different respects from the first embodiment will be mainly described as to the modeling system and modeling apparatus, the modeling method, and the modeling program according to the present embodiment.

In the present embodiment, a correction unit 44 sets a forming direction of a modifying path of a correction member based on a shape of a lacking part. In the first embodiment, it has been described that the path direction is fixed when setting the modifying path, and in the present embodiment, the path direction is also a control target.

The correction unit 44 sets the path direction corresponding to each of pattern 1 and pattern 2.

First, a case of the pattern 1 will be described.

In the pattern 1, as described above, the modifying path is formed only in the lacking part. Consequently, in the pattern 1, the correction unit 44 sets a forming direction of a path of a correction member so as to decrease the number of paths of the correction member, based on the shape of the lacking part.

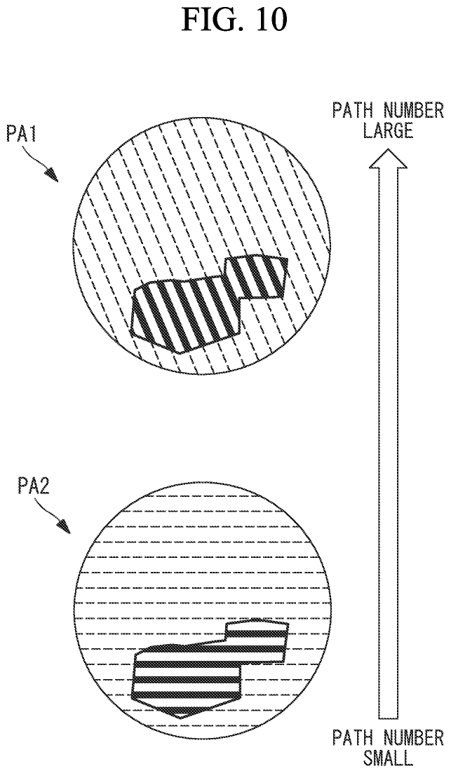

In the case of the pattern 1, bead edges (start and end edges) may be generated near edges of the lacking part. The edges have a possibility of affecting the modeling of the next layer, and hence the correction unit 44 sets the path direction so as to decrease the number of modifying paths to be formed in the lacking part. For example, the number of the modifying paths is about 12 in a path direction of PA1 in FIG. 10 (image diagram), but when a path direction of PA2 is set, the number of the modifying paths can be about seven. Specifically, in PA2, formation of bead edges in the lacking part is more inhibited. The number of the modifying paths depends on the shape of the lacking part, and hence the path direction is set based on the shape of the lacking part.

To decrease the number of the paths, it is more preferable to calculate the path direction that minimizes the number of paths. However, the number of the paths may be smaller than a predetermined number set beforehand, or a path direction pattern in which the number of the paths is smallest may be selected from a limited number of patterns. A method is not limited, as long as the path direction is set to decrease the number of the paths.

Beads are formed along a modifying path in the path direction set in this manner, so that the number of path edges (start and end edges) to be formed in the lacking part can be suppressed, and influences of the edges exerted on the modeling can be suppressed. This can improve a modeling accuracy.

Next, description will be made as to a case of pattern 2.

In the pattern 2, a modifying path is formed to pass through a lacking part as described above. Consequently, in the pattern 2, the correction unit 44 sets a forming direction of a path of a correction member so as to shorten a total distance of modifying paths, based on a shape of the lacking part.

In the case of the pattern 2, bead edges can be outside a range of a surface of a modeling layer including the lacking part, and hence influences of edges exerted on the next layer are suppressed. However, the total distance of the modifying paths tends to lengthen, and hence a modeling time and cost are preferably reduced. Consequently, the correction unit 44 sets a path direction so as to shorten the total distance of the modifying paths.

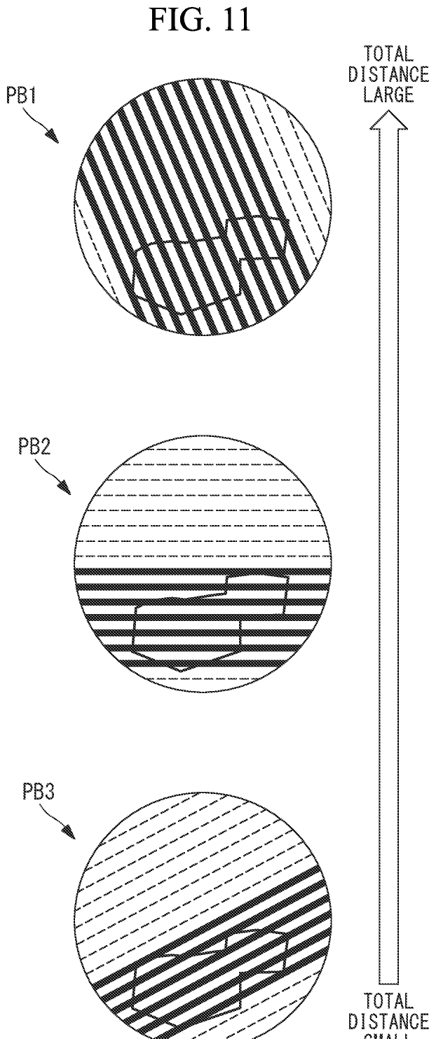

For example, the total distance of the modifying paths is shorter in a path direction of PB2 than in a path direction of PB1 in FIG. 11 (image diagram). Furthermore, the total distance of the modifying paths is shorter in a path direction of PB3 than in the path direction of PB2. That is, in the example of FIG. 11, the total distance of the modifying paths is shortest in the path direction of PB3. The total distance of the modifying paths depends on the shape of the lacking part, and hence the path direction is set based on the shape of the lacking part.

To shorten the total distance of the modifying paths, it is more preferable to calculate the path direction that minimizes the total distance. However, the total distance may be smaller than a predetermined distance set beforehand, or a path direction pattern in which the total distance is smallest may be selected from a limited number of patterns. A method is not limited, as long as the path direction is set to shorten the total distance of the modifying paths.

Thus, the path direction is also controlled, so that extra modifying paths can be suppressed, and the modeling time and cost can be reduced.

Note that in the present embodiment, it has been described that the modifying path is linear, but a modifying path other than the linear modifying path may be adopted. Also, in this case, similar effects can be obtained in the pattern 1 in which the path direction is set to decrease the number of the paths and the pattern 2 in which the path direction is set to shorten the total distance of the modifying paths.

As described above, according to the modeling system and modeling apparatus, the modeling method, and the modeling program of the present embodiment, the forming direction of the path of the correction member is set based on the shape of the lacking part, so that an amount of the correction member for use can be reduced, and a modeling accuracy can be improved.

The forming direction of the path of the correction member is set to decrease the number of the paths of the correction member, based on the shape of the lacking part, so that the number of path edges (start and end edges) to be formed in the lacking part can be reduced, and influences of the edges exerted on the modeling can be suppressed. This can improve the modeling accuracy.

The forming direction of the path of the correction member is set to shorten the total distance of the paths of the correction member, based on the shape of the lacking part, so that the modeling time and cost can be reduced.

The present disclosure is not limited only to the above embodiments, and various modifications can be made without departing from the scope of the invention. Note that the respective embodiments may be combined. That is, the above first and second embodiments may be combined.

The aforementioned modeling system and modeling apparatus, modeling method and modeling program described in each embodiment can be grasped, for example, as follows.

A modeling system (22) according to the present disclosure comprises a control unit (42) that controls a modeling means (23) to form each of stacked modeling layers, based on modeling data representing a three-dimensional model object that is a modeling target by use of a plurality of modeling layers, a determination unit (43) that determines whether or not a measured value of a stacked height of the formed modeling layer is within a predetermined range set beforehand and including a stacked height of the modeling layer in the modeling data, and in a case where the formed modeling layer has a lacking part in which the stacked height is not within the predetermined range, a correction unit (44) that performs correction modeling by forming a correction member in the lacking part such that the stacked height is within the predetermined range.

According to the modeling system of the present disclosure, when forming the respective stacked modeling layers, the correction modeling is performed in a case where there is the lacking part in which the stacked height of the formed modeling layer is not within the predetermined range including the stacked height of the modeling layer in the modeling data (the ideal stacked height). This correction modeling is performed such that the stacked height of the lacking part is within the predetermined range. Consequently, the stacked height of the modeling layer can be more securely brought close to the modeling data (ideal). That is, stable modeling is possible, and it is possible to form a high-quality model object having, for example, less internal defect or less incomplete fusion.

In the modeling system according to the present disclosure, the predetermined range may be set beforehand as a range in which the modeling layer to be stacked on the formed modeling layer can be formed such that the stacked height is equal to or more than a predetermined threshold value, based on specifications of the modeling means.

According to the modeling system of the present disclosure, the predetermined range is set as the range in which the modeling layer to be formed next (the modeling layer to be stacked on the formed modeling layer) can be formed such that the stacked height is equal to or more than the predetermined threshold value, based on the specifications of the modeling means. Consequently, even if there is the lacking part in the formed modeling layer, the correction modeling is performed, so that the modeling layer to be formed next can more securely indicate the threshold value or more, and it is possible to inhibit generation of a depressed part.

In the modeling system according to the present disclosure, the correction unit may perform the correction modeling by forming a path of the correction member only in the lacking part.

According to the modeling system of the present disclosure, the path of the correction member is formed only in the lacking part, and hence the formation of the correction member in a part other than the lacking part can be inhibited. Consequently, a modeling time and cost can be reduced.

In the modeling system according to the present disclosure, the correction unit may perform correction modeling by forming a path of the correction member that passes through the lacking part in the formed modeling layer including the lacking part.

According to the modeling system of the present disclosure, the path of the correction member that passes through the lacking part is formed in the modeling layer including the lacking part, and hence the correction member can be prevented from being formed in a region of the modeling layer that does not pass through the lacking part. Consequently, the modeling time and cost can be reduced.

In the modeling system according to the present disclosure, the correction unit may set a forming direction of the path of the correction member based on a shape of the lacking part.

According to the modeling system of the present disclosure, the forming direction of the path of the correction member is set based on the shape of the lacking part, so that an amount of the correction member for use can be reduced, and a modeling accuracy can be improved.

In the modeling system according to the present disclosure, the correction unit may set a forming direction of the path of the correction member so as to decrease the number of paths of the correction member, based on a shape of the lacking part.

According to the modeling system of the present disclosure, the forming direction of the path of the correction member is set to decrease the number of the paths of the correction member, based on the shape of the lacking part, so that the number of path edges (start or end edges) to be formed in the lacking part can be suppressed, and influences of the edges exerted on the modeling can be suppressed. This can improve the modeling accuracy.

In the modeling system according to the present disclosure, the correction unit may set the forming direction of the path of the correction member so as to shorten a total distance of the paths of the correction member, based on a shape of the lacking part.

According to the modeling system of the present disclosure, the forming direction of the path of the correction member is set to shorten the total distance of the paths of the correction member, based on the shape of the lacking part, so that the modeling time and cost can be reduced.

In the modeling system according to the present disclosure, the determination unit may perform determination processing after each of the modeling layers is formed, and the correction unit may perform the correction modeling before the modeling layer to be stacked next is formed, in a case where it is determined in the determination processing that there is the lacking part.

According to the modeling system of the present disclosure, the determination processing is performed in each of the plurality of formed modeling layers, and the correction modeling is performed before the next layer is formed in a case where there is the lacking part. That is, if there is the lacking part even in middle of the modeling, the correction modeling can be performed.

A modeling apparatus (20) comprises a modeling means that stacks a modeling material to form a modeling layer, and the above modeling system.

A modeling method according to the present disclosure includes a step of controlling a modeling means to form each of stacked modeling layers, based on modeling data representing a three-dimensional model object that is a modeling target by use of a plurality of modeling layers, a step of determining whether or not a measured value of a stacked height of the formed modeling layer is within a predetermined range set beforehand and including a stacked height of the modeling layer in the modeling data, and in a case where the formed modeling layer has a lacking part in which the stacked height is not within the predetermined range, a step of performing correction modeling by forming a correction member in the lacking part such that the stacked height is within the predetermined range.

According to the present disclosure, provided is a modeling program that causes a computer to execute processing of controlling a modeling means to form each of stacked modeling layers, based on modeling data representing a three-dimensional model object that is a modeling target by use of a plurality of modeling layers, processing of determining whether or not a measured value of a stacked height of the formed modeling layer is within a predetermined range set beforehand and including a stacked height of the modeling layer in the modeling data, and in a case where the formed modeling layer has a lacking part in which the stacked height is not within the predetermined range, processing of performing correction modeling by forming a correction member in the lacking part such that the stacked height is within the predetermined range.

### REFERENCE SIGN LIST

11 CPU
12 ROM
13 RAM
14 hard disk drive
15 communication unit
18 bus
20 modeling apparatus
22 control device (modeling system)
23 modeling means
31 head
32 stage
41 generation unit
42 control unit
43 determination unit
44 correction unit
L laser

What is claimed is:

1. A modeling system comprising:
a control unit that controls a modeling means to form each of stacked modeling layers, based on modeling data representing a three-dimensional model object that is a modeling target by use of a plurality of modeling layers,
a determination unit that determines whether or not a measured value of a stacked height of the formed modeling layer is within a predetermined range set beforehand and including a stacked height of the modeling layer in the modeling data, and
in a case where the formed modeling layer has a lacking part in which the stacked height is not within the predetermined range, a correction unit that performs correction modeling by forming a correction member in the lacking part such that the stacked height is within the predetermined range.

2. The modeling system according to claim 1, wherein the predetermined range is set beforehand as a range in which the modeling layer to be stacked on the formed modeling layer is formable such that the stacked height is equal to or more than a predetermined threshold value, based on specifications of the modeling means.

3. The modeling system according to claim 1, wherein the correction unit performs the correction modeling by forming a path of the correction member only in the lacking part.

4. The modeling system according to claim 1, wherein the correction unit performs the correction modeling by forming a path of the correction member that passes through the lacking part in the formed modeling layer including the lacking part.

5. The modeling system according to claim 3, wherein the correction unit sets a forming direction of the path of the correction member, based on a shape of the lacking part.

6. The modeling system according to claim 3, wherein the correction unit sets a forming direction of the path of the correction member so as to decrease the number of paths of the correction member, based on a shape of the lacking part.

7. The modeling system according to claim 4, wherein the correction unit sets a forming direction of the path of the correction member so as to shorten a total distance of the paths of the correction member, based on a shape of the lacking part.

8. The modeling system according to claim 1, wherein the determination unit performs determination processing after each of the modeling layers is formed, and
the correction unit performs the correction modeling before the modeling layer to be stacked next is formed, in a case where it is determined in the determination processing that there is the lacking part.

9. A modeling apparatus comprising:
a modeling means that stacks a modeling material to form a modeling layer, and
the modeling system according to claim 1.

10. A modeling method comprising:
a step of controlling a modeling means to form each of stacked modeling layers, based on modeling data representing a three-dimensional model object that is a modeling target by use of a plurality of modeling layers,
a step of measuring and determining whether or not a measured value of a stacked height of the formed modeling layer is within a predetermined range set beforehand and including a stacked height of the modeling layer in the modeling data, and
in a case where the formed modeling layer has a lacking part in which the stacked height is not within the predetermined range, a step of performing correction modeling by forming a correction member in the lacking part such that the stacked height is within the predetermined range.

11. A modeling program that causes a computer to execute:
processing of controlling a modeling means to form each of stacked modeling layers, based on modeling data representing a three-dimensional model object that is a modeling target by use of a plurality of modeling layers,
processing of measuring and determining whether or not a measured value of a stacked height of the formed modeling layer is within a predetermined range set beforehand and including a stacked height of the modeling layer in the modeling data, and
in a case where the formed modeling layer has a lacking part in which the stacked height is not within the predetermined range, processing of performing correction modeling by forming a correction member in the lacking part such that the stacked height is within the predetermined range.
